(19) United States
(12) Patent Application Publication
(10) Pub. No.: US 2025/0313325 A1
(43) Pub. Date: Oct. 9, 2025

(54) SHIP CONTROL DEVICE, SHIP CONTROL METHOD, AND COMPUTER READABLE MEDIUM

(71) Applicant: FURUNO ELECTRIC CO., LTD., Hyogo (JP)

(72) Inventor: Hideki UENO, Hyogo (JP)

(73) Assignee: FURUNO ELECTRIC CO., LTD., Hyogo (JP)

(21) Appl. No.: 19/044,273

(22) Filed: Feb. 3, 2025

(30) Foreign Application Priority Data
Apr. 5, 2024 (JP) 2024-061164

(51) Int. Cl. B63H 21/21; B63H 25/02; B63H 25/04

(52) U.S. Cl. CPC B63H 21/213; B63H 25/04; B63H 2021/216; B63H 2025/026

(57) ABSTRACT

A ship control device includes an input unit, an operation monitoring unit, and a ship holding unit. The input unit is inputted with an operating position of a ship operator for controlling the moving direction or propulsion of the ship. The operation monitoring unit detects an operation stationary state in which the operating position of the ship is unchanged for a predetermined time based on the time variation of the operating position of the ship. When the ship holding condition, including the detection of the operation stationary state, is satisfied, the ship holding unit performs ship holding control to hold the behavior of the ship.

### CROSS-REFERENCE TO RELATED APPLICATION(S)

The application claims priority under 35 U.S.C. § 119 to Japanese Patent Application No. 2024-061164, which was filed on Apr. 5, 2024, the entire disclosure of which is hereby incorporated by reference.

### TECHNICAL FIELD

The present invention relates to automatic navigation control of a ship at low speed.

### BACKGROUND

There are conventional automatic navigation devices which enables navigation using a joystick.

However, the conventional automatic navigation device is provided with a fixed point holding operation unit and a joystick. Therefore, switching operation between manual navigation using the joystick and automatic navigation using the fixed point holding operation unit is complicated for the operator. In addition, when the apparatus is not provided with such a configuration for separately operating manual navigation and automatic navigation, it is not easy to return to automatic navigation from various adjustments to automatic navigation.

Therefore, it is an object of the present invention to realize switching to automatic navigation by simple operation.

### SUMMARY

A ship control device according to an embodiment of the present invention includes an input unit, an operation monitoring unit, and a ship holding unit. The input unit inputs an operating position of an operating device that controls a moving direction or propulsion force of a ship. The operation monitoring unit detects an operation stationary state in which the operating position of the operating device does not change over a predetermined period of time based on a time variation in the operating position of the operating device. The ship holding unit performs ship holding control to hold a behavior of the ship when the ship holding condition, including the detection of the operation stationary state, is satisfied.

In this configuration, it is possible to switch to ship holding (automatic navigation) by not changing the operating device for a predetermined period of time. Therefore, switching to the automatic navigation may be realized with a simple operation.

In the ship control device according to an embodiment of the present invention, the operating device includes a joystick. The joystick may perform forward, neutral, and backward operations according to the operating position. The operation monitoring unit detects the operation stationary state in which the operating position corresponding to the forward operation or the backward operation by the joystick does not change for the predetermined time. The ship holding unit holds the propulsion force at the time when the detection by the operation monitoring unit occurs.

In this configuration, the behavior (direction of travel, propulsion) of the ship according to an operating state before switching to the automatic navigation is reflected during the automatic navigation.

In the ship control device according to an embodiment of the present invention, the operating device includes a joystick. The operation monitoring unit detects the operation stationary state when the operating position of the joystick remains neutral. The ship holding unit holds the moving direction of the ship at the time of detection by the operation monitoring unit.

In this configuration, switching to the automatic navigation may be performed by reflecting the intention of the user more surely while using simple operation of the joystick.

In the ship control device according to an embodiment of the present invention, the operating device includes a first switch that switches from manual navigation to automatic navigation. The ship control device includes an automatic navigation unit having a preliminary adjustment unit and a ship holding unit. When the operation of switching to automatic navigation is detected by the first switch, the preliminary adjustment unit sets a target value of the propulsion force of the ship to an initial propulsion force for holding the ship. The ship holding unit performs ship holding control to hold the initial propulsion force after the propulsion force of the ship becomes the initial propulsion force.

In this configuration, switching from manual navigation to automatic navigation may be performed by simple operation of the first switch through the state of the initial propulsion force.

In the ship control device according to an embodiment of the present invention, when a switch to automatic navigation by the first switch is detected, the preliminary adjustment unit approaches the initial propulsion force from the current propulsion force, for holding the ship, while adjusting an acceleration.

In this configuration, it is possible to suppress a sudden change in the ship speed at the transition from manual navigation to automatic navigation.

In the ship control device according to an embodiment of the present invention, the operation monitoring unit detects the operation stationary state by keeping the operating position of the joystick neutral after the ship holding control for holding the initial propulsion force starts. The ship holding unit holds the moving direction of the ship at the time when the operation stationary state is detected.

In this configuration, it is possible to suppress a sudden change in the moving direction of the ship at the transition from manual navigation to automatic navigation.

In the ship control device according to an embodiment of the present invention, the ship holding unit adjusts the propulsion force at the time of holding the ship based on an operation in the longitudinal direction during the ship holding control.

In this configuration, the propulsion force during automatic navigation may be easily adjusted by the joystick.

In the ship control device according to an embodiment of the present invention, the operating device is provided with a second switch that receives the operation of controlling an intermittent propulsion force. The intermittent control unit starts intermittent control based on the operation of the second switch during ship holding control.

In this configuration, automatic navigation at a lower speed may be realized.

In the ship control device according to an embodiment of the present invention, the intermittent control unit is provided with a third switch that accepts the operation of switching the control pattern of the intermittent control in the operating device. The intermittent control unit switches the control pattern of intermittent control based on the operation of the third switch.

In this configuration, the propulsion force during intermittent control may be adjusted.

In the ship control apparatus according to an embodiment of the present invention, the second switch also serves as the third switch.

In this configuration, the number of components for intermittent control may be reduced.

In the ship control apparatus according to an embodiment of the present invention, the ship holding unit cancels the ship holding control when the operation of the first switch is detected during the ship holding control.

In this configuration, the ship holding control (automatic navigation control) may be released by a simple operation of the first switch.

In the ship control device according to an embodiment of the present invention, the control unit cancels the automatic navigation control when it detects that the joystick is operated to the automatic navigation control release state.

In this configuration, the automatic navigation may be released by a simple operation of the joystick.

The ship control device according to an embodiment of the present invention includes an input unit, a preliminary adjustment unit, and a ship holding unit. The input unit receives the input of the operation of the joystick for controlling the behavior of the ship and the operation of the first switch for switching from manual navigation to automatic navigation. When the first switch detects the operation of switching to automatic navigation, the preliminary adjustment unit sets the target value of the propulsion force of the ship to the initial propulsion force for holding the ship. When the ship holding condition, including that the propulsion force of the ship becomes the initial propulsion force, is satisfied, the ship holding unit performs the ship holding control with the initial propulsion force.

In this configuration, it is possible to shift from manual navigation (manual navigation) to automatic navigation (automatic navigation: ship holding control) through the state of initial propulsion by operation of the joystick. Therefore, safe switching from manual navigation to automatic navigation may be realized with simple operation.

The ship control device according to an embodiment of the present invention is provided with an operation monitoring unit which detects an operation stationary state in which the operating position of the joystick is neutral and does not change for a predetermined time during ship holding control. The ship holding unit holds the moving direction of the ship at the time when detection by the operation monitoring unit occurs.

In this configuration, the ship moves from manual navigation to automatic navigation reflecting the intention of the user more surely, and the moving direction of the ship desired by the user may be held.

In the ship control device according to an embodiment of the present invention, the behavior of the ship includes the moving direction including the rudder angle or course of the ship, or at least one of throttle opening, engine speed, and speed of the ship, and the propulsion force.

In this configuration, specific examples of moving direction and propulsion force are shown, and at least one of them may be controlled.

### BRIEF DESCRIPTION OF DRAWINGS

The illustrated embodiments of the subject matter may be best understood by reference to the drawings, wherein like parts are designated by like numerals throughout. The following description is intended only by way of example, and simply illustrates certain selected embodiments of devices, systems, and processes that are consistent with the subject matter as claimed herein:

FIG. 1 is a plan view of a filter according to an embodiment of the present disclosure;

FIG. 2 is an external perspective view of a joystick;

FIGS. 3A, 3B, and 3C are diagrams for explaining the behavior of the joystick;

FIG. 4(A) is a diagram showing an example of the relationship between the position of the head viewed in plan view and the value of the operation input value (x) and the value of the operation input value (y), and FIG. 4(B) is a diagram showing an example of the relationship between the rotation amount of the head and the value of the operation input value (z);

FIG. 5 is a diagram showing an example of a plurality of operation buttons;

FIG. 6 is a diagram showing the relationship of each control in the low-speed navigation control mode;

FIG. 7(A) is a diagram showing an example of the time variation of the throttle opening in the normal throttle control, and FIGS. 7(B), 7(C), and 7(D) are diagrams showing an example of the time variation of the throttle opening in the multi-step intermittent throttle control;

FIG. 8 is a diagram showing an example of the behavior of a ship in the low-speed navigation control mode;

FIG. 9 is a flowchart showing a schematic process of a ship control method according to an embodiment of the present invention;

FIG. 10 is a flowchart showing a transition from the manual operation mode to the automatic navigation control mode in the low-speed navigation control mode;

FIG. 11 is a flowchart showing an adjustment of the initial throttle opening in the automatic navigation control mode;

FIG. 12 is a flowchart showing an adjustment of the initial throttle opening in the automatic navigation control mode;

FIGS. 13(A) and 13(B) are flowcharts showing an adjustment of the throttle opening in the automatic navigation control mode;

FIG. 14 is a flowchart for adjusting the command rudder angle in the automatic navigation control mode;

FIG. 15 is a flowchart for controlling the intermittent throttle in the automatic navigation control mode;

### DETAILED DESCRIPTION OF THE EMBODIMENTS

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, may be arranged, substituted, combined, separated, and designed in a wide variety of different configurations, all of which are explicitly contemplated herein.

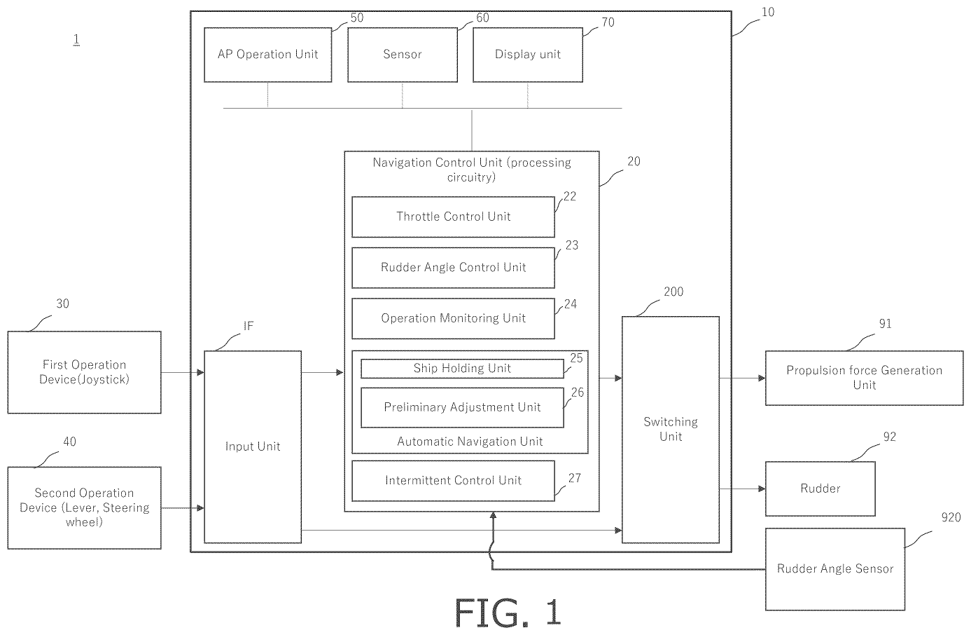

A ship control technology (Ship control device, ship control method, and ship control program) according to an embodiment of the present invention may be described with reference to the figures. FIG. 1 is a functional block diagram showing an example of the configuration of a ship control system including a ship control device according to an embodiment of the present invention.

(Configuration of the ship control system 1 and the ship control device 10) As shown in FIG. 1, the ship control system 1 includes a ship control device 10, a first operating device 30, a second operation device 40, a propulsion force generation unit 91, a rudder 92, and a rudder angle sensor 920. The first operation device corresponds to the “operation device” of the present invention.

The ship control device 10 includes a navigation control unit 20, an AP operation unit 50, a sensor 60, a display unit 70, a switching unit 200, and an input unit IF.

The ship control system 1 is installed, for example, in the ship 90 performing autopilot control (automatic navigation control).

The navigation control unit 20, the AP operation unit 50, the sensor 60, and the display unit 70 are connected to each other by, for example, a data communication network 100 for the ship. The navigation control unit 20 is connected to the switching unit 200.

The navigation control unit 20 is realized by, for example, a program for executing a function described later, a storage medium for storing the program, and an arithmetic processing unit (which is also referred to as a processing circuitry) for executing the program.

The navigation control unit 20 includes a throttle control unit 22, a rudder angle control unit 23, an operation monitoring unit 24, a ship holding unit 25, a preliminary adjustment unit 26, and an intermittent control unit 27. The ship holding unit 25 and the preliminary adjustment unit 26 constitute an automatic navigation unit.

The first operating device 30 and the second operation device 40 are installed, for example, in the wheelhouse of the ship 90.

The first operating device 30 is connected to the navigation control unit 20. The first operating device 30 includes a joystick, and a plurality of operation buttons arranged around the joystick. The first operating device 30 generates an operation input value based on the operation input from the user, and outputs it to the navigation control unit 20 through the input unit IF.

The second operation device 40 is connected to the switching unit 200 through the input unit IF. The second operation device 40 is, for example, a throttle lever and a steering wheel. The second operation device 40 generates an operation input value based on the operation input from the user and outputs it to the switching unit 200 through the input unit IF.

The AP operation unit 50 is implemented by, for example, a touch panel, a physical button or a switch. The AP operation unit 50 outputs settings related to high-speed automatic navigation (autopilot) control to the navigation control unit 20.

The sensor 60 measures the position of the ship 90 equipped with the ship control unit 10, the state of the ship such as heading and ship speed, and outputs it to the navigation control unit 20. For example, the sensor 60 is implemented by a positioning sensor using a positioning signal of GNSS (For example, GPS), an inertia sensor (Speed sensor, acceleration sensor, angular speed sensor, etc.), a magnetic sensor, and the like.

The display unit 70 is implemented by a liquid crystal panel, for example. The display unit 70 displays various information related to the ship control and the condition of the ship. The display unit 70 may be omitted, but it is preferable to have the display unit. By having the display unit 70, the user may easily grasp the status of ship control, condition of the ship and other information.

The propulsion force generation unit 91, the rudder 92, and the rudder angle sensor 920 are connected to the navigation control unit 20. The navigation control unit 20 and the propulsion force generation unit 91 are connected, for example, through a switching unit 200 and a propulsion communication network (CAN, etc.). The navigation control unit 20 and the rudder 92 are connected through the switching unit 200 and an analog or digital communication line. The navigation control unit 20 and the rudder angle sensor 920 are connected, for example, through an analog or digital communication line.

The propulsion force generation unit 91 and the rudder 92 are provided, for example, in an outboard motor, an inboard motor, and various propellers. The rudder mechanism rotates the rudder 92 by, for example, a hydraulic drive system to adjust the rudder angle.

The propulsion force generation unit 91 and the rudder 92 are, for example, each provided in the ship. That is, the ship 90 equipped with the ship control device 10 of the present embodiment is a so-called single-shaft and single-rudder ship (ship). The single-shaft and single-rudder ship (ship) refers to a ship (ship) having a single command system, even if it is multi-engine, and having equipment in which the rudder angle, shift for determining the moving direction, and throttle for determining the moving ship speed are synchronized. The rudder angle is a parameter for controlling the turning direction. The shift is a parameter for controlling the moving direction. The throttle is a parameter for controlling the moving ship speed.

The rudder angle sensor 920 measures the rudder angle (actual rudder angle) of the rudder 92 and outputs it to the navigation control unit 20.

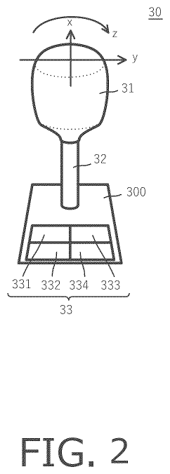

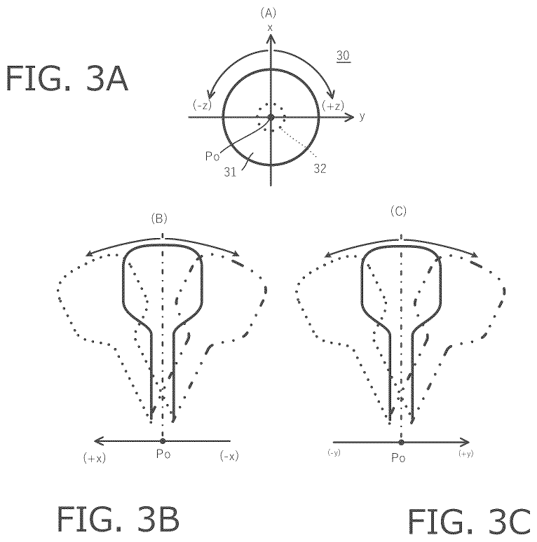

FIG. 2 is an external perspective view of the joystick. FIGS. 3(A), 3(B), and 3(C) are views for explaining the behavior of the joystick. FIG. 3(A) is a plan view, and FIGS. 3(B) and 3(C) are side views.

As shown in FIG. 2, the first operating device 30 includes a joystick (head 31 and shaft 32) and a group of buttons 33. The group of buttons 33 includes a plurality of operation buttons 331-334 (331, 332, 333, 334). The operation button 332 corresponds to the “first switch” of the present invention, and the operation button 333 corresponds to the “second switch” of the present invention. The operation buttons 333 and 334 correspond to the “third switch” of the present invention.

(Operation input by joystick) The root of the shaft 32 is fixed to a base (For example, the deck of the wheelhouse of ship 90) in a way that the planar position does not change. The head 31 is attached to the tip of the shaft 32. A plurality of operation buttons 331-334 constituting the button group 33 are arranged on the base near the root of the shaft 32.

The position of the tip of the shaft 32, that is, the position of the head 31, changes with respect to the root of the shaft 32 through the operation of the head 31 by the user. Specifically, as shown in FIGS. 3(B) and 3(C), a two-dimensional plane orthogonal to the axis of the shaft 32 is set. The default state (neutral state: when the user is not operating the head 31, i.e., the operation stop state) is used as the reference point Po for the position of the base of the shaft 32. The position of the head 31 changes with the operation (operation) of the user on this two-dimensional plane. For example, the position of the head 31 changes, when the user pushes or pulls the head 31 and tilts the shaft 32.

Furthermore, as shown in FIG. 3(A), the head 31 has a structure capable of rotating about the axis of the shaft 32.

The first operating device 30 includes an operation input value generating unit (not shown). The operation input value generating unit is, for example, a sensor for detecting the position of the head 31 on a two-dimensional plane and the amount of rotation of the head 31. The operation input value generating unit generates an operation input value corresponding to the position of the head 31 and the amount of rotation of the head 31.

Specifically, the operation input value generating unit detects the position of the head 31 in the direction parallel to the ship heading direction as the position in the x-axis direction, and generates an operation input value (x) based on this position. At this time, for example, the joystick value generating unit sets the forward direction in the +x direction and the backward direction in the −x direction, as shown in FIG. 3(B).

The operation input value generating unit detects the position of the head 31 in the direction orthogonal to the ship heading direction (right port direction) as the position in the y-axis direction, and generates an operation input value (y) based on this position. At this time, for example, the joystick value generating unit sets the starboard direction (right rotation direction) in the +y direction and the port direction (left rotation direction) in the −y direction, as shown in FIG. 3(C).

The operation input value generating unit detects the rotation direction and rotation angle (rotation amount) of the head 31, and generates an operation input value (z) based on the rotation direction and rotation angle. More specifically, the operation input value generating unit detects the rotation direction of the head 31 in a reference state in which the head 31 is not rotated. For example, the joystick value generating unit detects the rotation amount from the reference state in which the clockwise direction (clockwise) is set as the +z direction and the counterclockwise direction (counterclockwise) is set as the −z direction, and generates the operation input value (z), as shown in FIG. 3(A).

The operation input value generating unit outputs the operation input value (x), the operation input value (y), and the operation input value (z) to the navigation control unit 20.

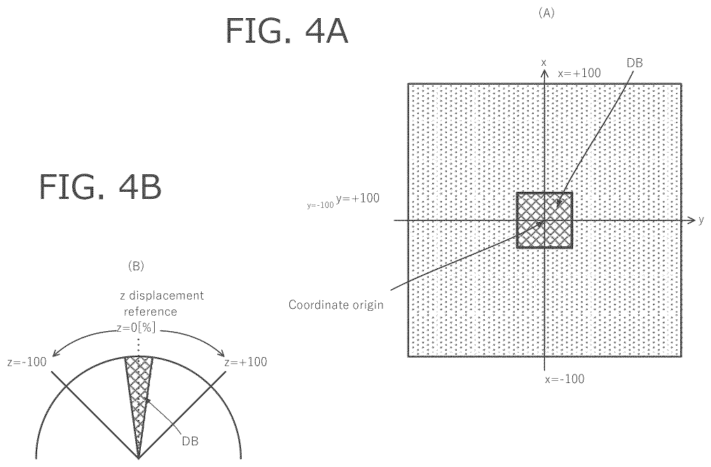

(Operation Input Value (x), Operation Input Value (y), Operation Input Value (z)) FIG. 4 (A) is a diagram showing an example of the relationship between the position of the head viewed from a plane and the value of the operation input value (x) and the value of the operation input value (y), and FIG. 4(B) is a diagram showing an example of the relationship between the rotation amount of the head and the value of the operation input value (z).

As shown in FIG. 4(A), the operation input value (x) is set to x=0 (coordinate origin) when the head 31 is in the default state (shift N). The operation input value (x) is the maximum value +100 when it is furthest from the default position in the forward direction. The operation input value (x) is set in a way that the value becomes larger as the position of the head 31 moves away from the default position in the +x direction in the two-dimensional plane.

The operation input value (x) becomes the minimum value −100 when it is furthest from the default position in the backward direction. The operation input value (x) is set in a way that the value becomes smaller as the position of the head 31 moves away from the default position in the −x direction in the two-dimensional plane.

When the operation input value (x) is within the DB range near 0 (see FIG. 4(A)), the throttle control unit 22 of the navigation control unit 20 sets the shift to N (neutral) and sets the throttle opening to the idle state.

When the operation input value (x) is a positive value (+value) outside the DB range, the throttle control unit 22 sets the shift to F (forward) in a way that the throttle opening becomes larger as the absolute value of the operation input value (x) increases. When the operation input value (x) is a negative value (−value) outside the DB range, the throttle control unit 22 sets the shift to R (backward) in a way that the throttle opening becomes larger as the absolute value of the operation input value (x) increases. The propulsive force of the ship 90 increases as the throttle opening increases, and the propulsive force of the ship 90 decreases as the throttle opening decreases. That is, the propulsion force is adjusted according to the throttle opening.

As shown in FIG. 4(A), the maximum value of the operation input value (y) is +100 when the head 31 is furthest from the default position in the starboard direction. The operation input value (y) is set in a way that the value becomes larger as the position of the head 31 moves further away from the default position in the +y direction in the two-dimensional plane.

The minimum value of the operation input value (y) is −100 when the head 31 is furthest from the default position in the port direction. The operation input value (y) is set in a way that the value becomes smaller as the position of the head 31 moves further away from the default position in the −y direction in the two-dimensional plane.

As shown in FIG. 4(B), the operation input value (z) represents the rotation state (rotation direction and rotation amount) of the head 31, and the maximum value z=+100 is obtained when the head 31 is most rotated from the default position in the right rotation direction when viewed from the tip side. When rotating to the right, the operation input value (z) is set in a way that the value increases as the amount of rotation from the default state (the absolute value of the rotation angle) increases.

The operation input value (z) becomes the minimum value −100 when the head 31 is rotated the most from the default position in the direction of left rotation when viewed from the front end side. When rotating to the left, the operation input value (z) is set in a way that the value becomes smaller as the amount of rotation (absolute value of rotation angle) from the default state increases.

The rudder angle control unit 23 of the navigation control unit 20 sets the command rudder angle based on the operation input value (y). For example, roughly, the rudder angle control unit 23 sets the command rudder angle to increase as the operation input value (y) increases.

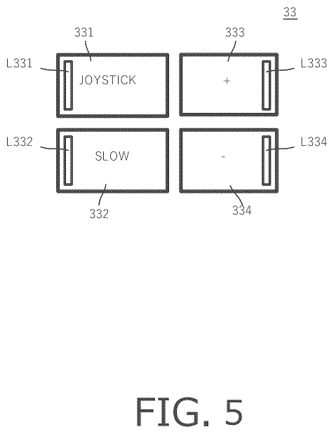

More specifically, when the operation input value (y) is within the DB range near 0 (see FIG. 5(A)), the rudder angle control unit 23 sets the rudder angle to the dead zone and sets the command rudder angle to 0°. When the operation input value (y) is a positive value (+value) outside the DB range, the rudder angle control unit 23 sets the rudder angle to the right and sets the command rudder angle to increase as the absolute value of the operation input value (y) increases.

When the operation input value (y) is outside the DB range and is a negative value (−value), the rudder angle control unit 23 sets the rudder angle to the left and sets the command rudder angle to increase as the absolute value of the operation input value (y) increases.

(Operation input by operation button group) A plurality of operation buttons 331-334 may be operated by a user by touching with a finger. FIG. 5 shows an example of a plurality of operation buttons.

The operation button 331 is a button used for selecting to enable or disable joystick operation. For example, if the operation button 331 is operated (For example, touch, press) while the joystick is disabled, the joystick gets enabled. The operation button 331 may be operated when the ship speed is below the switching threshold and the throttle lever, and the joystick are in shift N (neutral). On the other hand, if the operation button 331 is operated while the joystick is enabled, the joystick gets disabled.

The operation button 332 is a button used for selecting to enable or disable the low-speed automatic navigation control mode. For example, when the low-speed manual navigation mode is executed, operating the operation button 332 (For example, touch, press) enables the low-speed automatic navigation control mode. If the operation button 332 is operated while the low-speed automatic navigation control mode is enabled, the low-speed automatic navigation control mode is disabled and the low-speed automatic navigation mode is shifted to the low-speed manual navigation mode.

The operation button 333 is mainly a button for increasing the duty during intermittent throttle control. The operation button 334 is mainly a button for decreasing the duty during intermittent throttle control.

The operation button 334 (“−” button) is also used as a start trigger for intermittent throttle control. The operation button 333 (“+” button) is also used as an end trigger for intermittent throttle control.

The operation buttons 333 and 334 may also be used to set the maximum throttle opening during manual navigation control in the low-speed navigation control mode. In this case, the throttle control unit 22 sets the throttle opening according to the operation input value (x) of the joystick during the manual navigation control, and in accordance with the operation state of the operation buttons 333 and 334.

The first ship detects the operation to the plurality of operation buttons 331-334 and outputs the operation result to the navigation control unit 20.

The operation monitoring unit 24 of the navigation control unit 20 enables the joystick when the operation of the operation button 331 is input while the joystick is disabled. The operation monitoring unit 24 disables the joystick when the operation of the operation button 331 is input while the joystick is enabled.

The operation monitoring unit 24 switches from the high-speed navigation control mode to the low-speed navigation control mode when the operation of the operation button 332 is input during execution of the high-speed navigation control mode. The operation monitoring unit 24 switches from the low-speed navigation control mode to the high-speed navigation control mode when the operation of the operation button 332 is input during execution of the low-speed navigation control mode.

The intermittent control unit 27 sets the intermittent throttle according to the operation state of the operation buttons 333 and 334.

The operation button 331 is provided with a light-emitting element L331. For example, the light-emitting element L331 lights up when the operation by the joystick is effective and turns off when the operation by the joystick is ineffective.

The operation button 332 is provided with a light-emitting element L332. For example, the light-emitting element L332 lights up when the low-speed automatic navigation control mode is effective (when the low-speed manual navigation mode is ineffective) and turns off when the low-speed automatic navigation control mode is ineffective (when the low-speed manual navigation mode is effective).

The operation button 333 is provided with a light-emitting element L333, and the operation button 334 is provided with a light-emitting element L334. The light emitting element L333 lights up and turns off according to the operation state of the operation button 333, and the light emitting element L334 lights up and turns off according to the operation state of the operation button 334.

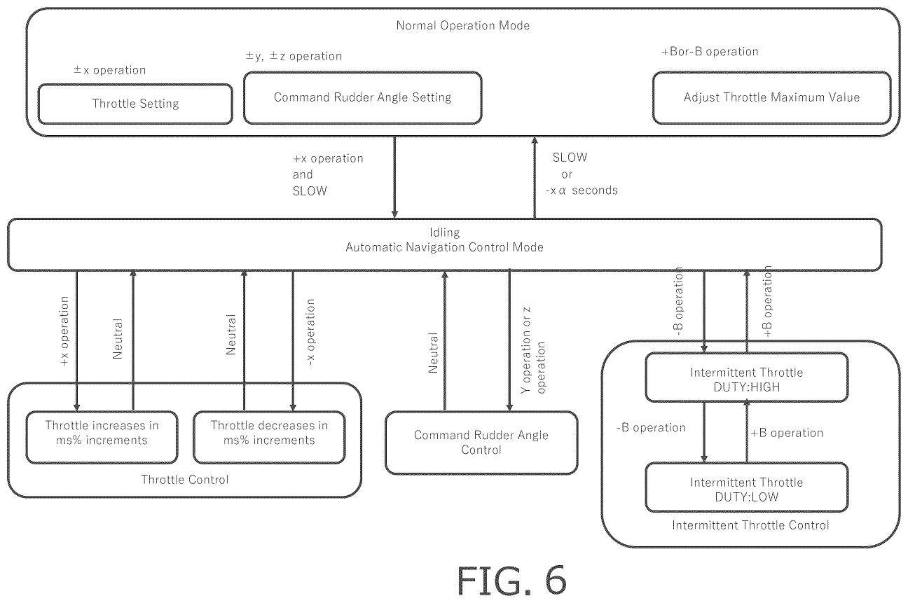

(Relationship of Controls in the Low-Speed Navigation Control Mode) FIG. 6 is a diagram showing the relationship of controls in the low-speed navigation control mode. The low-speed navigation control mode has two main modes: a normal operation mode and an automatic navigation control mode. In the normal operation mode, the throttle opening and the command rudder angle are set manually according to the operation state of the joystick. In the automatic navigation control mode, the automatic navigation control is performed at the specified throttle opening while keeping the direction in order to hold the heading at that time.

(Normal operation mode) (Throttle opening) In the normal operation mode, the throttle control unit 22 of the navigation control unit 20 sets the throttle opening based on ±x operation (operation input value (x)) of the joystick.

For example, if the operation input value (x) is positive and outside the DB range, the throttle control unit 22 sets shift F (forward) and sets the throttle opening according to the magnitude of the absolute value of the operation input value (x). If the operation input value (x) is negative and out of the DB range, the throttle control unit 22 sets the shift R (backward) and sets the throttle opening according to the magnitude of the absolute value of the operation input value (x).

In the normal operation mode, the throttle control unit 22 adjusts the throttle maximum value based on the operation of the operation buttons 333 and 334. The throttle maximum value is the throttle opening set when the joystick is operated to +100 or −100. The throttle maximum value may be set in a predetermined number of steps.

For example, the throttle control unit 22 increases the throttle maximum value by a predetermined amount or a predetermined percentage when the operation button 333 is operated. The throttle control unit 22 decreases the throttle maximum value by a predetermined amount or a predetermined percentage when the operation button 334 is operated.

(Command rudder angle) In the normal operation mode, the rudder angle control unit 23 of the navigation control unit 20 sets the command rudder angle based on ty operation (operation input value (y)) or ±z operation (operation input value (z)) of the joystick.

For example, if the operation input value (y) or the operation input value (z) is a positive value and outside the DB range, the rudder angle control unit 23 sets a right rotation and sets a command rudder angle corresponding to the magnitude of the absolute value of the operation input value (y) or the operation input value (z). If the operation input value (y) or the operation input value (z) is a negative value and outside the DB range, the rudder angle control unit 23 sets a left rotation and sets a command rudder angle corresponding to the magnitude of the absolute value of the operation input value (y) or the operation input value (z).

(Switching Between the Normal Operation Mode and the Automatic Navigation Control Mode) In the normal operation mode, if the joystick is +x operated (tilting forward) and the operation button 332 is operated, and then the joystick is held in a neutral state (position of the reference point Po or within the DB range) for a predetermined time (the operation is stopped), the operation monitoring unit 24 detects this operation and the automatic navigation unit shifts from the normal operation mode to the automatic navigation control mode.

Thus, the ship control device 10 may shift from the normal operation mode to the automatic navigation control mode with a simple operation. Moreover, since the combination of the operation of the joystick and the operation of the operation button 332 is used, the ship control device 10 may suppress an undesired shift from the normal operation mode to the automatic navigation control mode with a simple combination of simple operations.

In the automatic navigation control mode, an initial throttle opening is set. The initial throttle opening degree is the throttle opening degree at the time of idling, so called, the throttle opening degree at the time of dead slow. The throttle opening degree at the time of idling is, for example, the minimum throttle opening degree at which the propulsion force generation unit 91 does not stop when the clutch is connected to the propulsion force generation unit 91 (e.g., engine) (loaded state). The initial propulsion force is determined by the initial throttle opening degree.

The preliminary adjusting unit 26 of the automatic navigation portion gradually changes the throttle opening degree from the throttle opening degree at the time of switching operation from the normal operation mode to the automatic navigation control mode to the initial throttle opening degree. The rate of change is set, for example, by a linear function, but is not limited thereto.

Thus, the rapid change in the ship speed at the time of the transition from the normal operation mode to the automatic navigation control mode may be suppressed. Therefore, the safety and riding comfort of the user are improved.

In addition, the ship holding unit 25 of the automatic navigation unit does not manually change the heading during the switching operation from the normal operation mode to the automatic navigation control mode, and may suppress the sudden change of hands caused by the switching from the normal operation mode to the automatic navigation control mode. Therefore, the safety and riding comfort of the user may be improved, and the bow may be suppressed from turning in a direction not intended by the user.

When the operation button 332 is operated in the automatic navigation control mode, the operation monitoring unit 24 detects this, and the automatic navigation unit shifts from the automatic navigation control mode to the normal operation mode.

Alternatively, when the joystick is held in a predetermined range close to the maximum value for a predetermined time during the automatic navigation control mode, the operation monitoring unit 24 detects this, and the automatic navigation unit shifts from the automatic navigation control mode to the normal operation mode. The predetermined range at this time is, for example, x between −95 and −100, and the predetermined time is, for example, 2 seconds.

Thus, the ship control device 10 may shift from the automatic navigation control mode to the normal operation mode with a simple operation. In the case of the joystick operation, the undesirable shift from the automatic navigation control mode to the normal operation mode may be suppressed by limiting the designated range to a narrow range near the maximum value on the negative value side and providing a holding time.

(Automatic navigation control mode) The ship holding unit 25 starts the control by the automatic navigation control mode when it detects that the throttle opening of idling or the ship speed corresponding to the throttle opening of idling is reached. Basically, the automatic navigation control mode holds the throttle opening set. Moreover, the automatic navigation control mode automatically adjusts the command rudder angle in order to hold (hold) the heading. That is, the automatic navigation control performs the ship holding control.

Based on such schematic control, the automatic navigation control mode performs the following control.

(Adjustment of throttle opening) In the automatic navigation control mode, if +x operation (forward inclination operation) is performed on the joystick and the range is out of the DB range, the operation monitoring unit 24 detects this and the ship holding unit 25 increases the set value of the throttle opening by ms %. When the joystick is returned to the neutral state, the operation monitoring unit 24 detects this and the ship holding unit 25 reflects the increased throttle opening on the setting of the automatic navigation control mode.

In the automatic navigation control mode, if the joystick is out of the DB range by the −x operation (inclination operation in the backward direction), the operation monitoring unit 24 detects this and the ship holding unit 25 decreases the set value of the throttle opening by ms %. When the joystick is returned to the neutral state, the operation monitoring unit 24 detects this and the ship holding unit 25 reflects the reduced throttle opening to the setting of the automatic navigation control mode.

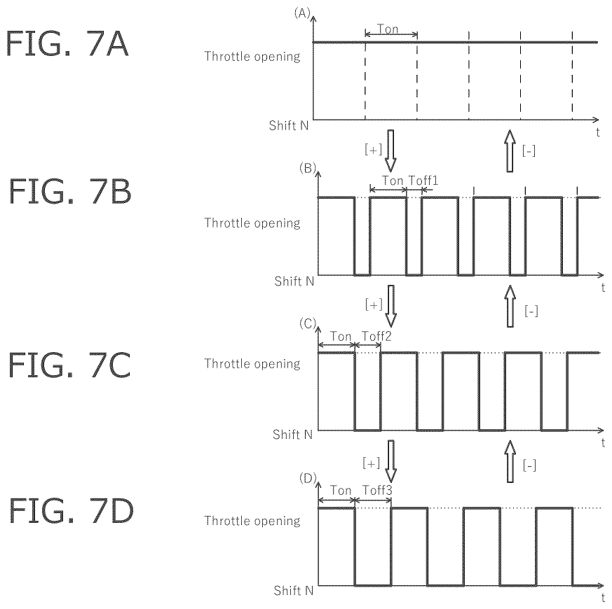

(Intermittent Throttle Control) FIG. 7(A) shows an example of the time variation of the throttle opening in the normal throttle control, and FIGS. 7(B), 7(C), and 7(D) show an example of the time variation of the throttle opening in the multi-step intermittent throttle control.

As shown in FIG. 7(A), in the normal throttle control, the throttle opening which is not 0 is always held constant. As shown in FIGS. 7(B), 7(C), and 7(D), in the intermittent throttle control, an on-time Ton in which the throttle opening which is not 0 is held and an off-time Toff in which the throttle opening which is 0 is held are set with a predetermined time length as one period of the intermittent throttle control.

Then, in each control cycle, the length of the off-time Toff is adjusted while keeping the on-time Ton constant. The length of the on-time Ton relative to the control cycle at this time is the DUTY of the intermittent throttle control. The length of the on-time Ton is, for example, set to a length that ensures the minimum required propulsion. By adjusting the DUTY, as shown in FIGS. 7(B), 7(C), and 7(D), the length of the on-time in one cycle is adjusted, and the actual throttle opening (the average throttle opening in one cycle) is adjusted.

The number of adjustment stages of the intermittent throttle control in the automatic navigation control mode is set in a plurality of stages. For example, in FIGS. 7(B), 7(C), and 7(D), it is set in three stages. It should be noted that the number of adjustment stages is not limited to three, and fine adjustment is possible as the number of adjustment stages increases. However, since the idling throttle opening is the standard and the speed is low, it is difficult to understand the difference in the actual throttle opening in each stage even if the number of adjustment stages is too large. Therefore, it is convenient to set in about three stages.

When the operation button 334 (“−” button) is operated in the automatic navigation control mode, the operation monitoring unit 24 detects this, and the intermittent control unit 27 shifts to the intermittent throttle control. At this time, the intermittent throttle control is shifted to the intermittent throttle control having the highest DUTY (shorter Toff time) in the intermittent throttle control set in a plurality of stages.

Thereafter, the intermittent control unit 27 shifts to the intermittent throttle control having a lower DUTY (longer Toff time) every time the operation button 334 (“−” button) is operated.

On the other hand, the intermittent control unit 27 shifts to the intermittent throttle control having a higher DUTY every time the operation button 333 (“+” button) is operated. When the operation button 333 (“+” button) is operated in the intermittent throttle control having the highest DUTY, the operation monitoring unit 24 detects this and the intermittent control unit 27 shifts from the intermittent throttle control to the normal throttle control.

Thus, the ship control device 10 may set the intermittent throttle control by a simple operation.

Furthermore, the ship control device 10 may shift from the normal throttle control to the intermittent throttle control by using the operation button 334 (“−” button) for switching the intermittent throttle control of a plurality of stages. Thus, the user may easily understand the transition operation from the normal throttle control to the intermittent throttle control while suppressing the increase in the number of operation buttons.

In addition, the ship control device 10 may shift from the intermittent throttle control to the normal throttle control by using the operation button 333 (“+” button) for switching between the intermittent throttle control of a plurality of stages. Thus, the user may easily understand the transition operation from the intermittent throttle control to the normal throttle control while suppressing the increase in the number of operation buttons.

(Command rudder angle control) In the automatic navigation control mode, if +y operation (lateral tilt operation) or +z operation (twist operation of the head 31) is performed on the joystick and the range is out of the DB range, the operation monitoring unit 24 detects this and the ship holding unit 25 suspends the direction holding control and shifts to the control for manually setting the command rudder angle.

The rudder angle control unit 23 sets the command rudder angle based on the operation state (operation input value (y) or operation input value (z)) of the joystick. When the joystick is returned to the neutral state, the operation monitoring unit 24 detects this and the ship holding unit 25 resumes the direction holding control in order to hold the heading at that time.

Thus, the ship control device 10 may adjust the heading in the automatic navigation control mode with easy operation.

In this way, the ship control device 10 realizes the change of the throttle opening and the adjustment of the command rudder angle in the automatic navigation control mode by combining the front/rear, left/right, and twist operations of the joystick and returning the joystick to the neutral state (operation stop state). In other words, the ship control device 10 changes the throttle opening and the adjustment of the command rudder angle in the automatic navigation control mode with the neutral state (operation stop state) of the joystick as a trigger after the front/rear, left/right, and twist operations of the joystick.

Thus, the ship control device 10 may realize the change of the throttle opening and the adjustment of the command rudder angle in the automatic navigation control mode by clearly reflecting the intention of the user. In other words, the ship control device 10 may suppress the change of the throttle opening and the adjustment of the command rudder angle in the automatic navigation control mode undesired by the user.

In addition, the ship control device 10 enables the adjustment of the throttle opening in the automatic navigation control mode by temporarily putting the joystick in the neutral state (operation stop state) after the operation of the operation button 332 during the transition from the normal operation mode to the automatic navigation control mode. Thus, the ship control device 10 may clearly separate the adjustment of the throttle opening in the normal operation mode from the adjustment of the throttle opening in the automatic navigation control mode. In other words, the ship control device 10 may suppress the shift from the normal operation mode to the automatic navigation control mode which is not desired by the user.

The navigation control unit 20 may also perform the following control.

When the operation monitoring unit 24 detects the operation stationary state in which the specific operation state of the joystick does not change for a predetermined time, the ship holding unit 25 holds the throttle opening or the propulsion force at the time of detection by the operation monitoring unit 24.

For example, when the maximum operation (+100) of the +x operation of the joystick is performed and is held, the operation monitoring unit 24 detects that this operation is held, and the ship holding unit 25 holds the throttle opening or the propulsion force at this time (the time of detection by the operation monitoring unit 24).

Thus, the user may easily hold the desired throttle opening and propulsion force (ship speed).

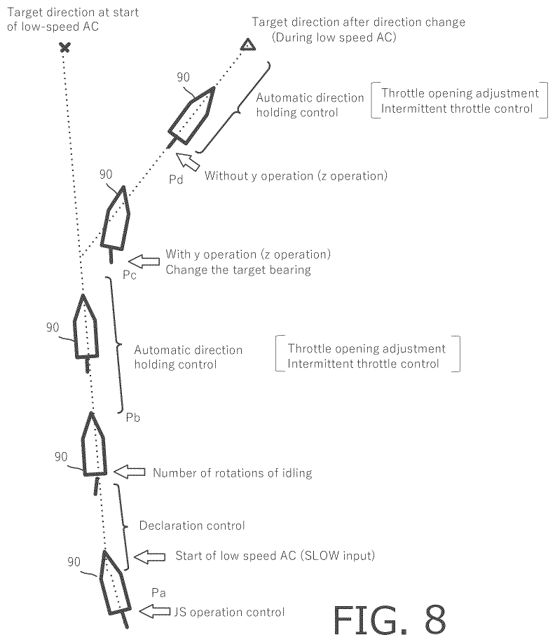

FIG. 8 is a diagram showing an example of the behavior of the ship in the low-speed navigation control mode. FIG. 8 shows a state of shifting from the joystick operation control (manual navigation mode) to the automatic navigation control mode. In the explanation of FIG. 8, the navigation control unit 20 is used as the subject, but each control is performed by the above-described function units that constitute the navigation control unit 20.

First, at time Pa, the manual navigation mode using the joystick is executed. Then, when the user operates the operation button 332 (“SLOW” button), the automatic navigation control mode (low speed AC) is started. At this time, the navigation control unit 20 automatically controls the command rudder angle in a way that the heading at the start timing of the automatic navigation control mode is held as the target heading.

Then, the navigation control unit 20 gradually decreases the throttle opening in order to reach the idling speed. Thus, the ship gradually decelerates.

When the throttle opening corresponding to the idling speed is reached (time Pb), the navigation control unit 20 performs automatic direction holding control in a way that the throttle opening is held, and the heading is directed to the target bearing.

At this time, as described above, when the user operates the joystick in the forward and backward directions, the navigation control unit 20 adjusts the adjustment of the maximum value of the throttle opening based on the operation input value (x) obtained by operating the joystick in the forward and backward directions. When the user operates the operation buttons 333 and 334, the navigation control unit 20 performs intermittent throttle control.

When lateral operation or twisting operation of the joystick is performed (time Pc) during automatic direction holding control, the navigation control unit 20 interrupts the automatic direction holding control. The navigation control unit 20 manually adjusts the command rudder angle based on the operation input value (y) obtained by lateral operation of the joystick or the operation input value (z) obtained by twisting operation. At this time, the navigation control unit 20 discards the target bearing so far.

When the lateral or twisting operation of the joystick is completed and the state of neutral (operation stop state) is reached, the navigation control unit 20 automatically controls the command rudder angle in order to hold the heading at this timing as the target heading.

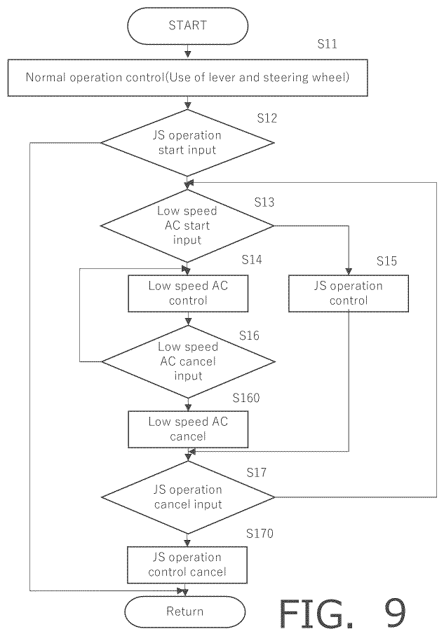

(Ship Control Method) FIG. 9 is a flowchart showing a schematic process of the ship control method according to the embodiment of the present invention. In the description of each control (process) shown in FIG. 9 and subsequent figures, the details described in the above configuration are omitted. In FIG. 9 and subsequent figures, “AC” means the automatic navigation control mode of the low-speed navigation control mode, and “JS” means the joystick.

In the description of FIG. 9 and subsequent figures, the subject of the process is mainly “the ship control unit 10” or “the navigation control unit 20”, but in more detail, the process is executed by the above-described functional units.

The ship control device 10 executes the normal operation control (high-speed navigation control mode) (S11). At this time, a throttle lever and a steering wheel are used.

When detecting the operation start input (operation button 331) by the joystick (S12: YES), the ship control device 10 shifts to the low-speed navigation control mode (normal operation mode). At this time, the ship control device 10 accepts the operation to the operation button 331 only when the throttle lever and the joystick are at shift N.

Thus, the ship control device 10 may suppress the unintentional shift to the low-speed navigation control mode by the negative desired operation to the operation button 331. If the ship control device 10 does not accept the operation start input (operation button 331) by the joystick (S12: NO), the high-speed navigation control mode is retained.

When the ship control device 10 detects an operation input (Forward tilt operation of the joystick and operation button 332 (“SLOW” button)) for starting the automatic navigation control mode in the low-speed navigation control mode (S13: YES), the ship control device shifts to the automatic navigation control mode (S14). If the operation input of the automatic navigation control mode is not accepted (S13: NO), the ship control device 10 executes a manual operation control mode using a joystick (S15).

The ship control device 10 cancels the automatic navigation control mode (S160) when an operation input (Retry the operation button 332 or hold the maximum backward tilt operation of the joystick for a predetermined time.) for canceling the automatic navigation control mode is detected (S16: YES).

The ship control device 10 releases the low-speed navigation control mode using the joystick (S170) and switches to the high-speed navigation control mode when detecting an operation input (re-operation of the operation button 331) for releasing the low-speed navigation control mode (normal operation mode) using the joystick (S17: YES). At this time, the ship control device 10 switches to the high-speed navigation control mode only when the throttle lever is at shift N. Thus, the ship control device 10 may prevent a sudden advance and a sudden backward movement after switching to the high-speed navigation control mode.

The ship control device 10 holds the low-speed navigation control mode until detecting an operation input (re-operation of the operation button 331) for releasing the low-speed navigation control mode using the joystick (S17: NO).

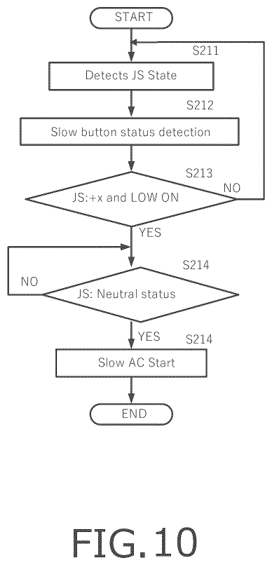

(Transition from the manual operation mode to the automatic navigation control mode in the low-speed navigation control mode) FIG. 10 is a flowchart of the transition from the manual operation mode to the automatic navigation control mode in the low-speed navigation control mode.

The navigation control unit 20 detects the operating state of the joystick (S211). The navigation control unit 20 detects the state of the operation button 332 (“SLOW” button) (S212).

The navigation control unit 20 detects whether the joystick is in the neutral state (operation stop state) when the joystick is in the forward inclination operating state (+x operation state) and the operation button 332 (“SLOW” button) is operated to the ON state (S213: YES). On the other hand, the navigation control unit 20 continues the manual operation mode if the joystick is in the forward inclination operating state (+x operation state) and the operation button 332 (“SLOW” button) is not in the ON state (S213: NO).

If the joystick is in the neutral state (operation stop state) (S214: YES), the navigation control unit 20 shifts to the automatic navigation control mode (S215). On the other hand, if the joystick is not in the neutral state (operation stop state) (S214: NO), the navigation control unit 20 waits for the shift to the automatic navigation control mode. More specifically, if the operation button 332 (“SLOW” button) is in the ON state, the navigation control unit 20 adjusts the initial throttle opening (initial adjustment of the throttle opening) described later. After that, when the joystick is in the neutral state (operation stop state), the navigation control unit 20 enables the adjustment of the throttle opening in the automatic navigation control mode. On the other hand, the navigation control unit 20 does not enable the adjustment of the throttle opening in the automatic navigation control mode until the joystick becomes the neutral state (operation stop state).

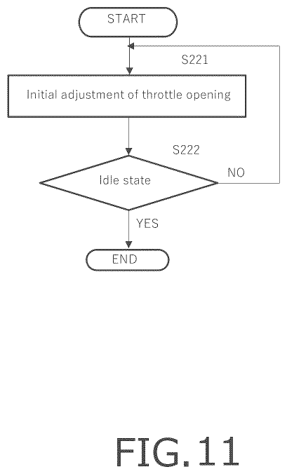

(Adjustment of the Initial Throttle Opening in the Automatic Navigation Control Mode) FIG. 11 is a flowchart of the adjustment of the initial throttle opening in the automatic navigation control mode.

When the navigation control unit 20 detects the switching operation to the automatic navigation mode, the navigation control unit performs the initial adjustment of the throttle opening in a way that the throttle opening becomes the preset initial throttle opening as described above (S221). The initial throttle opening is the throttle opening corresponding to the idling state.

The navigation control unit 20 gradually decreases the throttle opening until the initial throttle opening is reached (S222: NO). When the initial throttle opening is reached (S222: YES), the navigation control unit 20 substantially starts the automatic navigation mode.

At this time, the navigation control unit 20 may obtain the ship speed and adjust the throttle opening and substantially start the automatic navigation control mode depending on whether the ship speed is in the idling state.

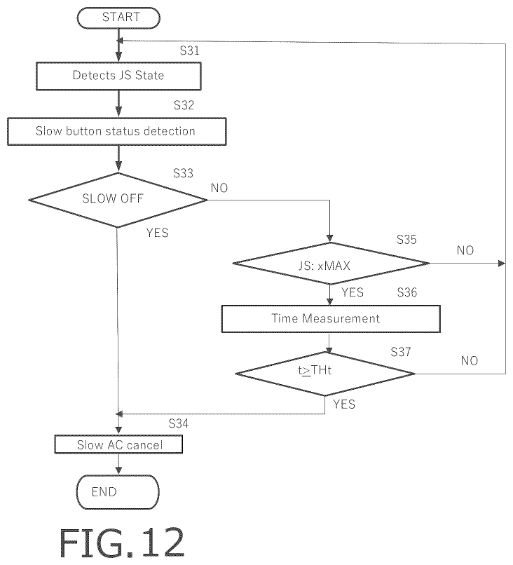

(Canceling the Automatic Navigation Control Mode) FIG. 12 is a flowchart for canceling the automatic navigation control mode.

The navigation control unit 20 detects the operating state of the joystick in the automatic navigation control mode (S31). The navigation control unit 20 detects the operating state of the operation button 332 (“SLOW” button) in the automatic navigation control mode (S212).

When the operation button 332 is operated to the OFF state (S213: YES), the navigation control unit 20 cancels the automatic navigation control mode (S34).

Even if the operation button 332 is not operated to the OFF state (S213: NO), the navigation control unit 20 performs timing (S36) if the joystick is tilted close to the maximum in the backward operation (S35: YES). On the other hand, the navigation control unit 20 continues the automatic navigation control mode when the operation button 332 is not operated in the OFF state (S213: NO) and the joystick is not tilted close to the maximum in the backward operation (S35: NO).

The navigation control unit 20 performs time counting, and if the operation state of the joystick is held for a predetermined time (YES at S37), cancels the automatic navigation control mode (S34). The navigation control unit 20 continues the automatic navigation control mode if the operation state of the joystick is not held for a predetermined time (NO at S37).

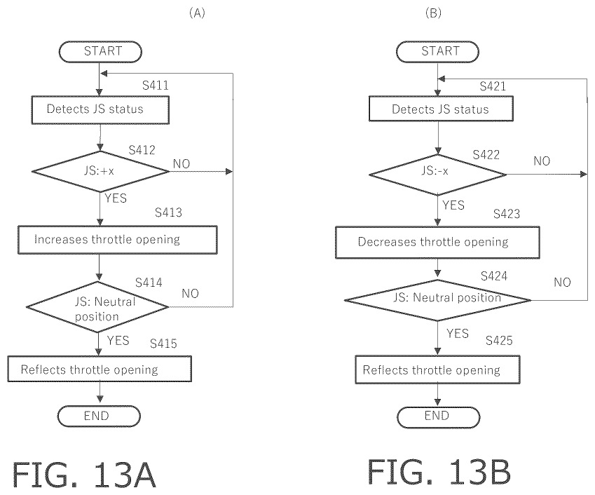

(Adjustment of Throttle Opening in the Automatic Navigation Control Mode) FIGS. 13(A) and 13(B) are flowcharts for adjusting the throttle opening in the automatic navigation control mode. FIG. 13(A) shows a case where the throttle opening is increased, and FIG. 13(B) shows a case where the throttle opening is decreased.

(Increase of the throttle opening: FIG. 13(A)) The navigation control unit 20 detects the operation state of the joystick in the automatic navigation control mode (S411). If the joystick is tilted forward (+x operation) (S412: YES), the navigation control unit 20 increases the throttle opening (S413). If the joystick is not tilted forward (+x operation) (S412: NO), the navigation control unit 20 holds the throttle opening.

If the joystick is in a neutral state (S414: YES), the navigation control unit 20 reflects the increased throttle opening to the throttle opening of the automatic navigation mode (S415). On the other hand, if the joystick is not in a neutral state (S414: NO), the increased throttle opening is not reflected in the throttle opening of the automatic navigation mode.

(Reduction of throttle opening: FIG. 13(B)) The navigation control unit 20 detects the operating state of the joystick in the automatic navigation control mode (S421). If the joystick is tilted backward (−x operation) (S422: YES), the navigation control unit 20 decreases the throttle opening (S423). If the joystick is not tilted backward (−x operation) (S422: NO), the navigation control unit 20 holds the throttle opening.

If the joystick is in a neutral state (S424: YES), the navigation control unit 20 reflects the reduced throttle opening to the throttle opening in the automatic navigation mode (S425). On the other hand, if the joystick is not in the neutral state (S424: NO), the reduced throttle opening is not reflected to the throttle opening in the automatic navigation mode.

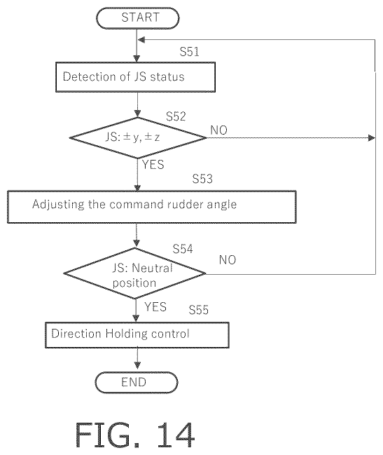

(Adjusting the command rudder angle in the automatic navigation mode) FIG. 14 is a flowchart for adjusting the command rudder angle in the automatic navigation control mode.

The navigation control unit 20 detects the operating state of the joystick in the automatic navigation control mode (S51). If the joystick is tilted (+y operation) or twisted (+z operation) in the lateral direction (S52: YES), the navigation control unit 20 suspends the direction holding control in the automatic navigation control and adjusts the command rudder angle (S53). At this time, the navigation control unit 20 does not change the throttle opening unless the throttle opening is adjusted by the joystick. On the other hand, if the joystick is not tilted (+y operation) or twisted (+z operation) in the lateral direction (S52: NO), the navigation control unit 20 continues the automatic navigation control (throttle opening holding and direction holding control).

If the joystick returns to the neutral state (S54: YES), the navigation control unit 20 returns to the automatic navigation control (throttle opening holding and direction holding control) (S55). On the other hand, the navigation control unit 20 continues adjusting the command rudder angle by the joystick operation until the joystick returns to the neutral state (S54: NO).

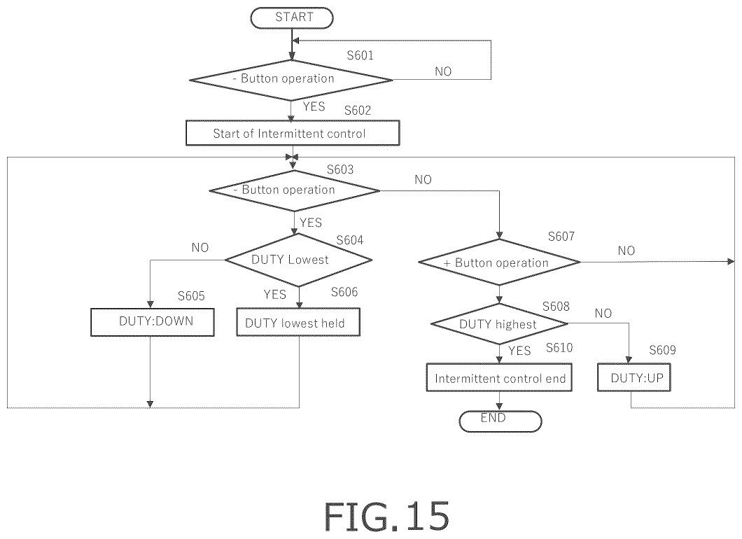

(Intermittent throttle control) FIG. 15 is a flowchart for intermittent throttle control in the automatic navigation control mode.

When the navigation control unit 20 detects the operation of the operation button 334 (“−” button) in the automatic navigation control mode (S601: YES), it starts the intermittent throttle control (S602). On the other hand, when the navigation control unit 20 does not detect the operation of the operation button 334 (“−” button) in the automatic navigation control mode (S601: NO), it does not start the intermittent throttle control.

After starting the intermittent throttle control, the navigation control unit 20 detects the operation of the operation button 334 (“−” button) (S603: YES), and if the DUTY is not the lowest (S604: NO), it reduces the DUTY (S605). The navigation control unit 20 detects the operation of the operation button 334 (“−” button) (S603: YES), and if the DUTY is the lowest (S604: YES), it holds the state of the lowest DUTY (S606).

After the start of the intermittent throttle control, the navigation control unit 20 does not detect the operation of the operation button 334 (“−” button) (S603: NO), detects the operation of the operation button 333 (“+” button) (S607: YES), and raises the DUTY if the DUTY is not the highest (S608: NO) (S609).

The navigation control unit 20 does not detect the operation of the operation button 334 (“−” button) (S603: NO), detects the operation of the operation button 333 (“+” button) (S607: YES), and terminates the intermittent throttle control if the DUTY is the highest (S608: YES) (S610).

The navigation control unit 20 retains the current DUTY if the operation of the operation button 334 (“−” button) is not detected (S603: NO) and the operation of the operation button 333 (“+” button) is not detected (S607: NO).

In the above description, the case of automatic navigation control (ship holding control) for moving forward at low speed is shown, but the above-described configuration and control may also be applied to moving backward at low speed.

### Terminology

It is to be understood that not necessarily all objectives or advantages may be achieved in accordance with any particular embodiment described herein. Thus, for example, those skilled in the art may appreciate that certain embodiments may be configured to operate in a manner that achieves or optimizes one advantage or group of advantages as taught herein without necessarily achieving other objects or advantages as may be taught or suggested herein.

All processes described herein may be embodied in, and fully automated via, software code modules executed by a computing system that includes one or more computers or processors. The software code modules may be stored in any type of non-transitory computer-readable medium or other computer storage device. Some or all methods may be embodied in specialized computer hardware.

Many other variations other than those described herein may be apparent from this disclosure. For example, depending on the embodiment, certain actions, events, or functions of any of the algorithms described herein may be performed in different sequences, and may be added, merged, or excluded altogether (e.g., not all described actions or events are required to execute the algorithm). Moreover, in certain embodiments, operations or events are performed in parallel, for example, through multithreading, interrupt handling, or through multiple processors or processor cores, or on other parallel architectures, rather than sequentially. In addition, different tasks or processes may be performed by different machines and/or computing systems that may work together.

The various exemplary logical blocks and modules described in connection with the embodiments disclosed herein may be implemented or executed by a machine such as a processor. The processor may be a microprocessor, but alternatively, the processor may be a controller, a microcontroller, or a state machine, or a combination thereof. The processor may include an electrical circuit configured to process computer executable instructions. In another embodiment, the processor includes an application specific integrated circuit (ASIC), a field programmable gate array (FPGA), or other programmable device that performs logical operations without processing computer executable instructions. The processor may also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, the processor may also include primarily analog components. For example, some or all of the signal processing algorithms described herein may be implemented by analog circuitry or mixed analog and digital circuitry. A computing environment may include any type of computer system, including, but not limited to, a computer system that is based on a microprocessor, mainframe computer, a digital signal processor, a portable computing device, a device controller, or a computing engine within the device.

Unless otherwise stated, conditional languages such as “can,” “could,” “will,” “might,” or “may” are understood within the context as used in general to convey that certain embodiments include, while other embodiments do not include, certain features, elements and/or steps. Thus, such conditional languages are not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive languages, such as the phrase “at least one of X, Y, or Z,” unless specifically stated otherwise, is understood with the context as used in general to present that an item, term, etc., may be either X, Y, or Z, or any combination thereof (e.g., X, Y, and/or Z). Thus, such a disjunctive language is not generally intended to, and should not, imply that certain embodiments require at least one of X, at least one of Y, or at least one of Z to each be present.

Any process descriptions, elements, or blocks in the flow diagrams described herein and/or shown in the accompanying drawings should be understood as potentially representing modules, segments, or parts of code, including one or more executable instructions for implementing a particular logical function or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices may also be collectively configured to carry out the stated recitations. For example, “a processor configured to carry out recitations A, B and C” may include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art may recognize that such recitation should typically be interpreted to mean at least the recited number (e.g., the bare recitation of “two recitations,” without other modifiers, typically means at least two recitations, or two or more recitations).

It may be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” may be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under” are defined with respect to the horizontal plane.

As used herein, the terms “attached,” “connected,” “coupled,” and other such relational terms should be construed, unless otherwise noted, to include removable, moveable, fixed, adjustable, and/or releasable connections or attachments. The connections/attachments may include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A ship control device, comprising:
an input unit configured to input an operating position of an operating device for controlling a moving direction or propulsion force of the ship; and
processing circuitry configured to:
detect an operation stationary state in which the operating position does not change for a predetermined time; and
perform ship holding control for holding a behavior of the ship in case a ship holding condition, including the detection of the operation stationary state, is satisfied.

2. The ship control device of claim 1,
wherein the operating device comprises:
a joystick configured to be capable of performing forward operation, neutral and backward operations according to the operating position,
wherein the processing circuitry is further configured to:
detect the operation stationary state in which the operating position corresponding to the forward operation or the backward operation by the joystick does not change for the predetermined time, and
hold the propulsion force at the time the detection occurs.

3. The ship control device of claim 1,
wherein the operating device comprises a joystick,
wherein the processing circuitry is further configured to:
detect the operation stationary state in case the operating position of the joystick remains in neutral, and
hold the movement direction of the ship at the time the detection occurs.

4. The ship control device of claim 1,
wherein the operating device comprises a first switch for switching from manual navigation to automatic navigation, and
wherein the processing circuitry is further configured to:
set a target value for the propulsion force of the ship to an initial propulsion force for holding the ship, upon detecting a switching operation of the first switch to automatic navigation,
perform the ship holding control for holding the initial propulsion force after the propulsion force of the ship becomes the initial propulsion force.

5. The ship control device of claim 4,
wherein the processing circuitry is further configured to:
approach the initial propulsion force from the current propulsion force for holding the ship while adjusting an acceleration, upon detecting the switching to the automatic navigation by the first switch.

6. The ship control device of claim 4,
wherein the processing circuitry is further configured to:
detect the operation stationary state in case the operating position of the joystick remains in neutral, after a start of the ship holding control for holding the initial propulsion force, and
hold the movement direction at the time the detection occurs.

7. The ship control device of claim 4,
wherein the processing circuitry is further configured to:
adjust the propulsion force at the time of the ship holding control based on an operation of the joystick in the bow-stern direction during the ship holding control.

8. The ship control device of claim 1,
wherein the operating device comprises a second switch for receiving an operation of an intermittent control of the propulsion force,
wherein the processing circuitry is further configured to:
start the intermittent control based on the operation of the second switch during the ship holding control.

9. The ship control device of claim 8,
wherein the processing circuitry is further configured to: switch a control pattern of the intermittent control based on an operation of a third switch which accepts an operation of switching the control pattern of the intermittent control in the operating device.

10. The ship control device of claim 9,
wherein the second switch also serves as the third switch.

11. The ship control device of claim 4,
wherein the processing circuitry is further configured to:
cancel the ship holding control in case an operation of the first switch is detected during the ship holding control.

12. The ship control device of claim 2,
wherein the processing circuitry is further configured to:
cancel the ship holding control in case an operation of the joystick to the ship holding control cancel state is detected.

13. The ship control device of claim 1,
wherein the behavior of the ship comprises the direction of movement comprising a rudder angle or a course of the ship, or the propulsion comprising a throttle opening, an engine speed, and a speed of the ship.

14. The ship control device of claim 6,
wherein the processing circuitry is further configured to:
adjust the propulsion force at the time of the ship holding control based on an operation of the joystick in the bow-stern direction during the ship holding control.

15. The ship control device of claim 14,
wherein the operating device comprises a second switch for receiving an operation of an intermittent control of the propulsion force,
wherein the processing circuitry is further configured to:
start the intermittent control based on the operation of the second switch during the ship holding control.

16. The ship control device of claim 15,
wherein the processing circuitry is further configured to: switch a control pattern of the intermittent control based on an operation of a third switch which accepts an operation of switching the control pattern of the intermittent control in the operating device.

17. The ship control device of claim 16,
wherein the second switch also serves as the third switch.

18. The ship control device of claim 17,
wherein the behavior of the ship comprises the direction of movement comprising a rudder angle or a course of the ship, or the propulsion comprising a throttle opening, an engine speed, and a speed of the ship.

19. A ship control method, comprising:
inputting an operating position of an operating device for controlling a moving direction or propulsion force of the ship;
detecting an operation stationary state in which the operating position does not change for a predetermined time based on a time variation in the operating position; and
performing ship holding control for holding a behavior of the ship in case a ship holding condition, including a detection of the operation stationary state, is satisfied.

20. A non-transitory computer-readable medium having stored thereon computer-executable instructions which, when executed by a computer, cause the computer to:
inputting an operating position of an operating device for controlling a moving direction or propulsion force of the ship;
detecting an operation stationary state in which the operating position does not change for a predetermined time based on a time variation in the operating position; and
performing ship holding control for holding a behavior of the ship in case a ship holding condition, including a detection of the operation stationary state, is satisfied.
